(19) United States
(12) Patent Application Publication
(10) Pub. No.: US 2010/0316142 A1
(43) Pub. Date: Dec. 16, 2010

(54) SEMICONDUCTOR INTEGRATED CIRCUIT AND DESIGNING METHOD THEREOF

(76) Inventors: Hironori Tsuchiya, Osaka (JP); Hirokuni Taketazu, Osaka (JP); Masanobu Mizuno, Osaka (JP)

Correspondence Address: MCDERMOTT WILL & EMERY LLP, 600 13TH STREET, NW, WASHINGTON, DC, 20005-3096, US

(21) Appl. No.: 12/514,834

(22) PCT Filed: Jul. 7, 2008
(86) PCT No.: PCT/JP2008/001809

§ 371 Date: May 14, 2009

(30) Foreign Application Priority Data
Dec. 27, 2007 (JP) 2007-337061

(51) Int. Cl. H04L 27/00

(52) U.S. Cl. 375/259

(57) ABSTRACT

Provided are an asynchronous anomaly detecting circuit (101) for receiving inputs of asynchronous transmission/reception related signals including transmission data, clock and control signals etc., determining whether or not they satisfy a given signal requirement and outputting an asynchronous anomaly information, and an asynchronous anomaly relief circuit (102) for receiving inputs of the asynchronous transmission/reception related signals including the transmission data, clock and control signals etc. as well as the asynchronous anomaly information and outputting the asynchronous transmission/reception related signals that have been relief-processed. These circuits allow relieving asynchronous anomalies in the semiconductor integrated circuit on a chip without requiring rework of a mask.

### TECHNICAL FIELD

The present invention relates to a technique for detecting and removing an anomaly in circuit operation occurring during passing of data between asynchronous clock domains in a semiconductor integrated circuit.

### BACKGROUND ART

A semiconductor integrated circuit includes a plurality of synchronous circuits which operate with various clocks having different phases and frequencies. A group of circuits which operate with the same clock is referred to as a clock domain. Data needs to be passed between different clock domains. Conventionally, data is passed between asynchronous clock domains using a data source flip-flop and a data destination flip-flop which operate with different clocks and are directly connected to each other.

This structure is prone to a problem called “metastability.” The metastability occurs when a data value is changed upon clock transition of the destination flip-flop. In this case, the output of the destination flip-flop fluctuates for a finite time period, i.e., the value of the flip-flop is indefinite for that time period. If this data propagates to a following logic circuit, an error or an unreliable operation occurs. To avoid this, another flip-flop is added, following the destination flip-flop (double buffer). As a result, even if the destination flip-flop outputs indefinite data, the indefinite data can be prevented from propagating to the following logic circuit. Since the metastable state generally becomes stable by the next clock edge, the added flip-flop outputs stable data.

Also, when a data value is changed upon clock transition of a flip-flop, there is another problem that the output does not have a normal value in addition to the metastability. This problem arises because when a change point is present in received data for a setup/hold time, it is uncertain whether the received data will take data before the change or data after the change. This problem cannot be solved by the aforementioned double buffer. To solve this problem, a data exchanging circuit for controlling the timing of exchanging data or a handshake data circuit employing a buffer device is used to reliably pass data without generating “data mislatch” which would otherwise occur when a change point is present in received data for a setup/hold time.

For example, Patent Document 1 discloses a data exchanging circuit in which when one data clock is exchanged for another data clock asynchronous therewith, the timing of exchanging data is controlled so as to prevent data error from occurring during exchanging. Patent Document 2 discloses a method and apparatus for passing data between asynchronous clock domains via a data buffer device.

### Patent Document 1: Japanese Unexamined Patent Application Publication: H08-237232

### Patent Document 2: International Publication WO 03/039061

### DISCLOSURE OF THE INVENTION

### Problems to be Solved by the Invention

In addition to the aforementioned problems, however, the asynchronous data passing has a “data loss” problem that data to be received is altered before the data arrives at a destination, so that the data cannot be acquired by a destination flip-flop. In this regard, correct data does not reach a destination, which is a problem different from those which have been conventionally solved.

Asynchronous data can be relatively safely passed by using the data exchanging circuit or the handshake circuit. In this case, however, it may be difficult to modify the circuit since the specifications of passing of data between clock domains are limited due to the reuse of circuit resources or there are many points where asynchronous passing is performed. Therefore, such a data passing circuit structure cannot be used in many cases. Therefore, in general, asynchronous passing is mostly achieved by using a structure in which a source flip-flop and a destination flip-flop are directly connected to each other.

Such an asynchronous passing structure depends on the timing of clocks, and therefore, reliable passing of data is not guaranteed. Therefore, the asynchronous passing structure essentially needs to be verified in terms of the aforementioned “metastability,” “data mislatch” and “data loss” problems and the like. This verification is conducted by logic simulation or circuit data structure verification during the RTL design stage. The asynchronous passing structure is developed, assuming that all operational anomalies are found and circuit modification is completed to remove the circuit operational anomalies before ordering a mask. However, it is difficult to comprehensively predict, during the design stage, a phase shift which would occur in a final product. At present, it is not possible to verify the asynchronous passing structure in terms of various clock phase relationships. As a result, a circuit operational anomaly may occur during evaluation of a chip or a product incorporating the chip, so that the mask may be remodeled, resulting in a cost of modification of the mask.

The present invention is provided to solve the aforementioned problems. An object of the present invention is to provide a circuit structure which monitors passing of data between asynchronous clock domains to determine whether a circuit operational anomaly has occurred, during evaluation of a chip or development of a product incorporating the chip, and when detecting a circuit operational anomaly, removes the circuit operational anomaly without remodeling a mask.

### Solution to the Problems

To achieve the object, a semiconductor integrated circuit according to the present invention is a semiconductor integrated circuit for passing data between asynchronous clock domains operating with different clocks, including, for example, an asynchronous anomaly detecting circuit and an asynchronous anomaly removing circuit as follows. The asynchronous anomaly detecting circuit has an asynchronous anomaly determining unit for receiving clock signals asynchronous with each other and a signal related to passing of data as input signals, and determining whether the input signals satisfy desired signal conditions. The asynchronous anomaly removing circuit has an asynchronous anomaly removing unit for modifying a signal state at an asynchronous passing point so as to satisfy the desired conditions when conditions under which data transfer is normally performed are not satisfied.

### EFFECT OF THE INVENTION

The present invention allows easy detection of an asynchronous anomaly using an asynchronous anomaly detecting circuit during evaluation of a chip or a product incorporating the chip even when an asynchronous passing point is not well verified during a design stage in an asynchronous passing portion which is difficult to perfectly verify, and an asynchronous anomaly is left in a developed chip. The present invention also can correct circuit data, or repairing an anomaly point without remodeling a mask, by enabling the asynchronous anomaly removing circuit even when a circuit anomaly is detected during evaluation of a chip or a product incorporating the chip.

### BRIEF DESCRIPTION OF THE DRAWINGS

FIG. 1 is a diagram showing a basic circuit configuration of an asynchronous passing portion according to the present invention.

FIG. 2 is a diagram showing a basic internal configuration of an asynchronous anomaly detecting circuit.

FIG. 3 is a diagram showing a basic internal configuration of an asynchronous anomaly removing circuit.

FIG. 4 is a diagram showing an asynchronous data transfer circuit.

FIG. 5 is a timing chart when a data transfer operation of FIG. 4 is normal.

FIG. 6 is a timing chart when the data transfer operation of FIG. 4 is not normal.

FIG. 7 is diagram showing an example configuration of an asynchronous anomaly detecting circuit which determines whether a sampling theorem is satisfied.

FIG. 8 is a diagram showing an asynchronous data transfer circuit using a control signal.

FIG. 9 is a timing chart when a data transfer operation of FIG. 8 is normal.

FIG. 10 is a timing chart when the data transfer operation of FIG. 8 is not normal.

FIG. 11 is a diagram showing an asynchronous anomaly detecting circuit which checks a data change point.

FIG. 12 is a diagram showing an asynchronous anomaly removing circuit which extends the length of transmitted data using flip-flops.

FIG. 13 is a timing chart when the asynchronous anomaly removing circuit of FIG. 12 is enabled.

FIG. 14 is a diagram showing an asynchronous anomaly removing circuit which extends the length of transmitted data using a data storing circuit.

FIG. 15 is a timing chart when the asynchronous anomaly removing circuit of FIG. 14 is enabled.

FIG. 16 is a diagram showing an asynchronous data transfer circuit which detects and removes a metastable anomaly.

FIG. 17 is a diagram showing an example configuration of a metastable anomaly detecting circuit of FIG. 16.

FIG. 18 is a diagram showing an example configuration of a metastable anomaly removing circuit of FIG. 16.

FIG. 19 is a diagram showing an example configuration when an output unit of FIG. 2 is configured in a scan chain.

FIG. 20 is a diagram showing an asynchronous anomaly removing circuit having a function of storing a history.

FIG. 21 is a diagram showing an example configuration of a system which controls an asynchronous anomaly detecting circuit and an asynchronous anomaly removing circuit.

FIG. 22 is a diagram showing an example initial startup routine of a semiconductor integrated circuit including an asynchronous anomaly detecting circuit and an asynchronous anomaly removing circuit.

FIG. 23 is a diagram showing an example design environment of a semiconductor integrated circuit including an asynchronous anomaly detecting circuit and an asynchronous anomaly removing circuit.

FIG. 24 is a diagram showing an example design flow for incorporating an asynchronous anomaly detecting circuit and an asynchronous anomaly removing circuit into a semiconductor integrated circuit.

### DESCRIPTION OF THE REFERENCE CHARACTERS

101 asynchronous anomaly detecting circuit
102 asynchronous anomaly removing circuit
201 asynchronous anomaly determining unit
202 output unit
301 asynchronous anomaly removing unit
302 removal switching unit
303 removing circuit control unit
401 data source flip-flop
402 data destination flip-flop
701 transmitted data change detecting circuit
702 receive clock counter circuit
703 transmitted data storing circuit
704 comparator
801 data source flip-flop
802 data destination flip-flop
1101 transmitted data storing circuit
1102 comparator
1204 to 1209 data delay flip-flop
1402 data storing circuit
1601 data source flip-flop
1602, 1603 data destination flip-flop
1604 metastable anomaly detecting circuit
1605 metastable anomaly removing circuit
1701 transmitted data change detecting circuit
1702 transmitted data storing circuit
1703 receive clock counter circuit
1704 comparator
1801 asynchronous anomaly removing unit
1802 removing circuit control unit
1803 removal switching unit
1804 to 1806 anti-metastable flip-flop
1901 to 1904 scan flip-flop
1905 data output control circuit
2001 asynchronous related signal history storing unit
2100 semiconductor integrated circuit
2101, 2102 clock domain circuit
2103 microcontroller unit (MCU)

### BEST MODE FOR CARRYING OUT THE INVENTION

Hereinafter, embodiments of the present invention relating to a method for verifying a semiconductor integrated circuit will be described with reference to the accompanying drawings.

### Embodiment 1

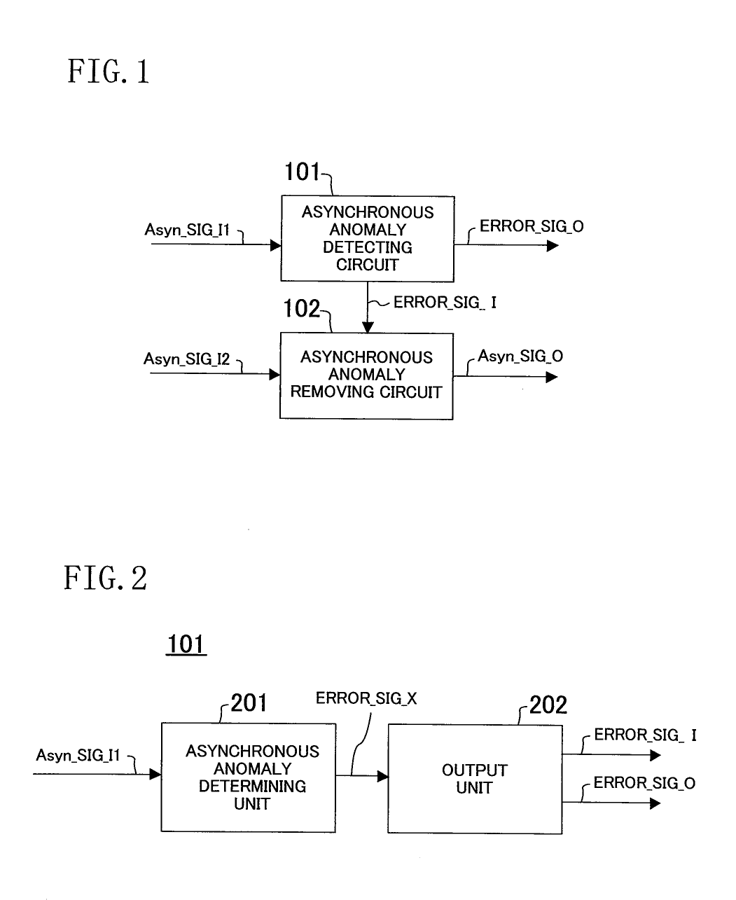

FIG. 1 shows a basic circuit configuration of an asynchronous passing portion in a semiconductor integrated circuit according to the present invention. Reference numeral 101 indicates an asynchronous anomaly detecting circuit which detects a circuit anomaly in asynchronous passing. Reference numeral 102 indicates an asynchronous anomaly removing circuit which removes an asynchronous anomaly.

The asynchronous anomaly detecting circuit 101 receives asynchronous passing related signals Asyn_SIG_I1, such as transmitted data, a clock, a control signal and the like, and outputs asynchronous anomaly information ERROR_SIG_I and ERROR_SIG_O. The asynchronous anomaly information ERROR_SIG_I is used in the semiconductor integrated circuit. The asynchronous anomaly information ERROR_SIG_O is output to the outside of the semiconductor integrated circuit.

The asynchronous anomaly removing circuit 102 receives asynchronous passing related signals Asyn_SIG_I2, such as transmitted data, a clock, a control signal and the like, and the asynchronous anomaly information ERROR_SIG_I, and outputs asynchronous passing related signals Asyn_SIG_O after removal of an anomaly. Note that the asynchronous passing related signals Asyn_SIG_I1 and Asyn_SIG_I2 vary depending on the kind of an asynchronous anomaly which is detected or removed.

FIG. 2 is a diagram showing a basic internal configuration of the asynchronous anomaly detecting circuit 101. The asynchronous anomaly detecting circuit 101 includes an asynchronous anomaly determining unit 201 which determines whether an input signal satisfies desired signal conditions with respect to predetermined signal conditions which should be satisfied so as to normally pass data, and an output unit 202 which outputs asynchronous anomaly information to the outside if the signal conditions are not satisfied. ERROR_SIG_X indicates asynchronous anomaly information which is passed from the asynchronous anomaly determining unit 201 to the output unit 202.

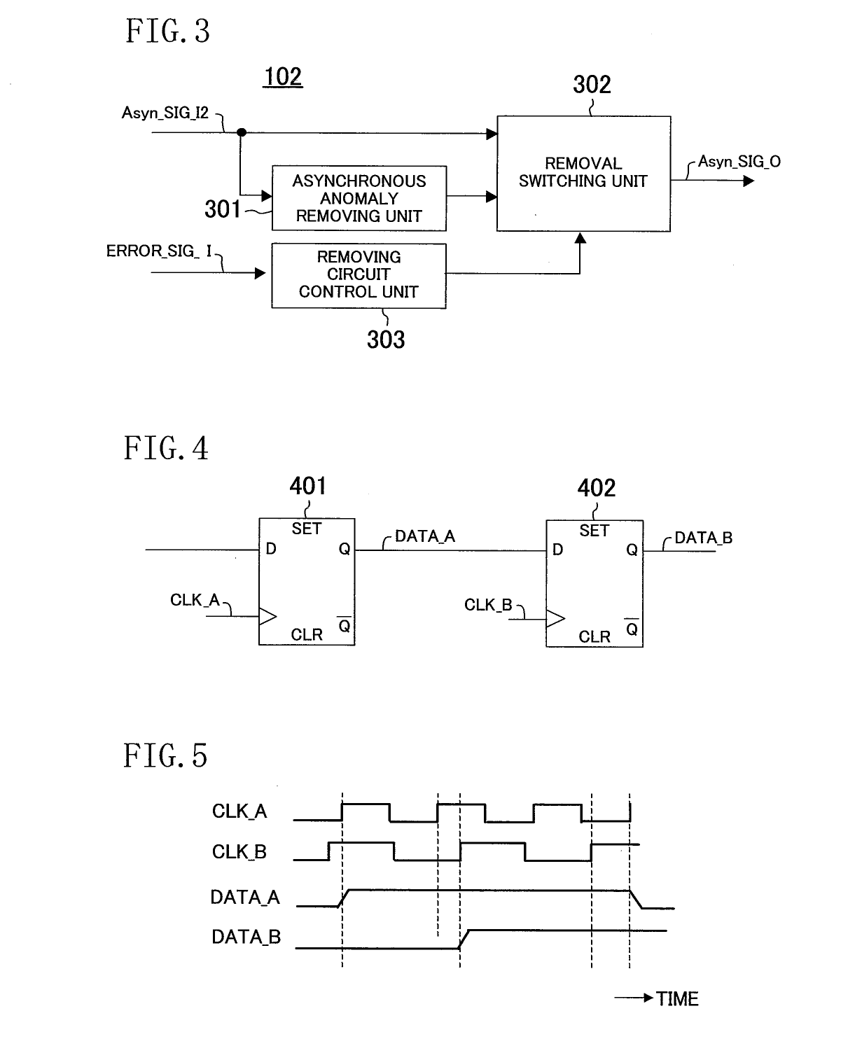

FIG. 3 is a diagram showing a basic internal configuration of the asynchronous anomaly removing circuit 102. The asynchronous anomaly removing circuit 102 includes an asynchronous anomaly removing unit 301 which modifies each signal state at an asynchronous passing point so as to satisfy the desired conditions when the signal state does not satisfy conditions under which data transfer is normally performed during asynchronous passing, a removal switching unit 302 which enables and disables the asynchronous anomaly removing unit 301 with respect to a circuit anomaly point, and a removing circuit control unit 303 which manages and recognizes a removal state and generates and outputs a control signal for controlling the removing circuit.

Initially, the asynchronous anomaly detecting circuit 101 determines whether the signal conditions to be satisfied for asynchronous passing are satisfied, using the determining unit 201. If the signal state does not satisfy the signal conditions to be satisfied, the asynchronous anomaly detecting circuit 101 outputs the asynchronous anomaly information ERROR_SIG_O and ERROR_SIG_I using the output unit 202. The output asynchronous anomaly information ERROR_SIG_I is input to the asynchronous anomaly removing circuit 102. When receiving the asynchronous anomaly information, the removing circuit 102 generates a control signal using the removing circuit control unit 303, and enables the asynchronous anomaly removing unit 301 using the removal switching unit 302. As a result, an asynchronous anomaly is removed.

### Embodiment 2

In the asynchronous anomaly detecting circuit 101 of Embodiment 1, a configuration is provided which determines whether each asynchronous related signal satisfies conditions which should be satisfied by a transmit clock, a receive clock and transmitted data so as to reliably receive data at a destination flip-flop without the transmitted data being lost before the destination flip-flop receives data. This configuration will be described.

FIG. 4 shows an asynchronous data transfer circuit which transfers data from a high-speed clock domain to a low-speed clock domain. Reference numeral 401 indicates a data source flip-flop, and reference numeral 402 indicates a data destination flip-flop. Also, CLK_A indicates a transmit clock, DATA_A indicates transmitted data, CLK_B indicates a receive clock, and DATA_B indicates received data. The flip-flops 401 and 402 operate with asynchronous clocks, so that data is asynchronously passed between the flip-flops 401 and 402.

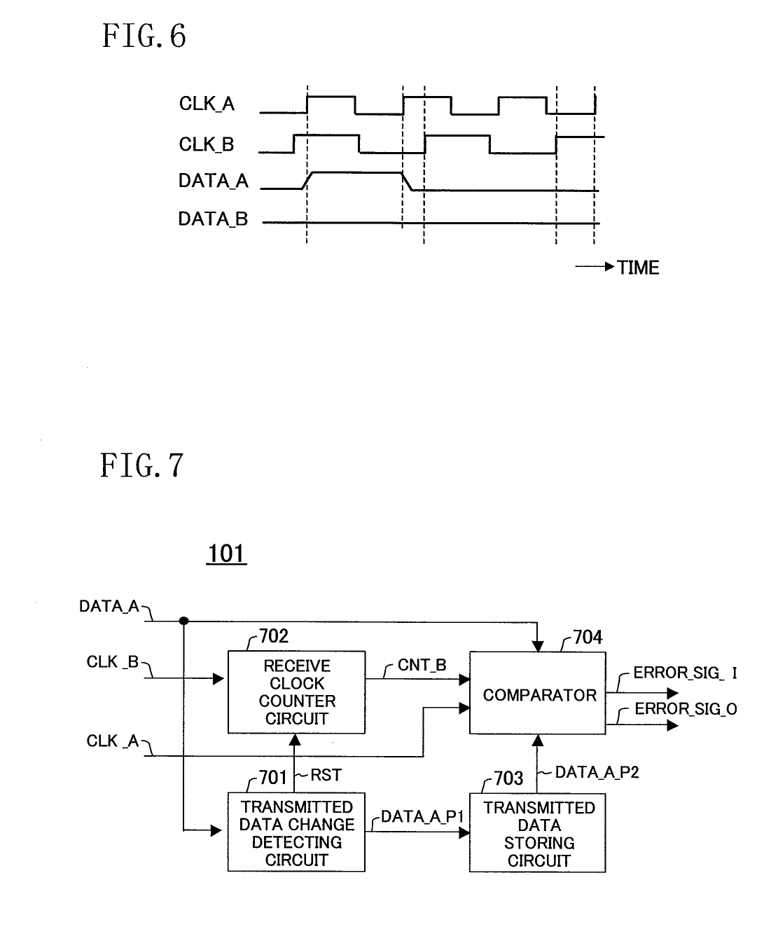

FIG. 5 shows a timing chart when the data transfer operation of FIG. 4 is normal. Also, FIG. 6 shows a timing chart when the data transfer operation of FIG. 4 is not normal. In FIG. 5, the transmitted data DATA_A is held for a sufficiently long time, so that data is normally transferred to the data destination flip-flop 402. In FIG. 6, since the transmitted data DATA_A changes before a rising edge of the receive clock CLK_B, the data is not normally transferred to the data destination flip-flop 402.

In order to reliably receive source data during asynchronous passing of data, the following relationship needs to be satisfied.

the width of transmitted data>the period of a receive clock

If conditions for the width of transmitted data are represented using the clock period and the number of clock cycles of each of transmit and receive clocks as parameters, the aforementioned relationship is modified as follows:

the number of cycles of transmitted data≧(the period of a receive clock+the period of a transmit clock)/the period of the transmit clock (Expression 1)

This relational expression needs to be satisfied. If the ratio of the periods is 1:1.2 (transmit clock:receive clock), the number of cycles of transmitted data is 2.2 or more. In this case, the value of transmitted data must not change for three transmit cycles. The conditions of (Expression 1) is herein referred to as a “sampling theorem.”

FIG. 7 shows an example circuit configuration which determines whether the aforementioned relationship is satisfied. An asynchronous anomaly detecting circuit 101 of FIG. 7 includes a transmitted data change detecting circuit 701 which detects a change point of transmitted data, a receive clock counter circuit 702 which counts a clock for a destination flip-flop, a transmitted data storing circuit 703 which temporarily holds transmitted data DATA_A_P1 as it is upon the data change, and a comparator 704 which receives a transmit clock CLK_A, a receive clock count value CNT_B, transmitted data DATA_A_P2 as it is upon the data change, which is stored in the transmitted data storing circuit 703, and the latest transmitted data DATA_A. Note that the transmitted data DATA_A, the transmit clock CLK_A and the receive clock CLK_B correspond to Asyn_SIG_I1 of FIG. 1.

The transmitted data change detecting circuit 701, when detecting a change in the transmitted data DATA_A, resets the receive clock counter circuit 702 in accordance with a reset signal RST. The count value CNT_B of the receive clock counter circuit 702 indicates a time for which the transmitted data DATA_A is held, in units of transmission cycles. When resetting the receive clock counter circuit 702, the transmitted data change detecting circuit 701 temporarily stores, in the transmitted data storing circuit 703, transmitted data DATA_A_P1 as it is at that time. The data DATA_A_P2 stored in the transmitted data storing circuit 703 is held until the start of the next checking.

The comparator 704 compares the transmitted data DATA_A_P2 as it is upon the data change with the latest transmitted data DATA_A to determine whether their data values match, for a transmit clock cycle time which begins since the changing of the transmitted data DATA_A and continues until the transmitted data DATA_A_P2 stored in the transmitted data storing circuit 703 and the transmitted data DATA_A satisfy the conditions of (Expression 1). If the data values do not match, the comparator 704 determines that an anomaly has occurred, and outputs asynchronous anomaly information ERROR_SIG_I and ERROR_SIG_O containing error information and information about the number of clock cycles short.

### Embodiment 3

In the asynchronous anomaly detecting circuit 101 of Embodiment 1, a configuration is provided which determines whether each signal satisfies conditions under which data is reliably received by a destination flip-flop during asynchronous data transfer between flip-flops with a control signal. This configuration will be described.

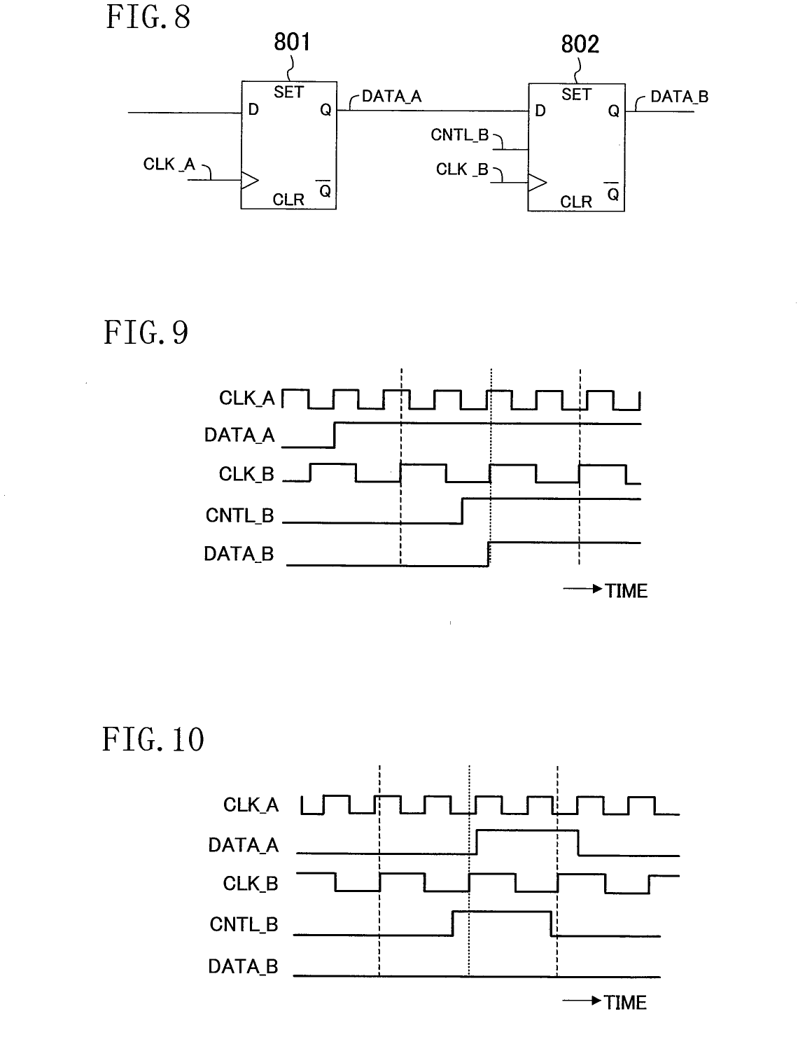

FIG. 8 shows a data transfer circuit which transfers data from a high-speed clock domain to a low-speed clock domain using a control signal. Reference numeral 801 indicates a data source flip-flop, and reference numeral 802 indicates a data destination flip-flop. Both of the flip-flops 801 and 802 operate with asynchronous clocks. When a control signal CNTL_B indicating the validity of data is asserted, the destination flip-flop 802 latches data transferred from the source flip-flop 801 with the timing of rising of the receive clock CLK_B.

FIG. 9 shows a timing chart when the data transfer operation of FIG. 8 is normal. FIG. 10 shows a timing chart when the data transfer operation of FIG. 8 is not normal. In the example of FIG. 9, transmitted data DATA_A does not change during the previous one cycle time (one destination clock period) and the next one cycle time (one destination clock period) with reference to the rising edge of the receive clock CLK_B following the assertion of the control signal CNTL_B. Therefore, data is normally transferred to the destination flip-flop 802. In the example of FIG. 10, however, transmitted data DATA_A changes during the previous one cycle time (one destination clock period) and the next one cycle time (one destination clock period) with reference to the rising edge of the receive clock CLK_B following the assertion of the control signal CNTL_B. In this case, in an actual circuit, data may not be normally transferred to the destination flip-flop 802, depending on the timing, due to a physical delay of a signal or a fluctuation in a clock.

In order to reliably transfer source data between asynchronous clock domains using such a control signal CNTL_B, transmitted data DATA_A needs not to change during the previous one cycle time (one destination clock period) and the next one cycle time (one destination clock period) with reference to the rising edge of the receive clock CLK_B following a change in the destination control signal CNTL_B. Determination of whether these conditions are satisfied is herein referred to as “data change point checking.”

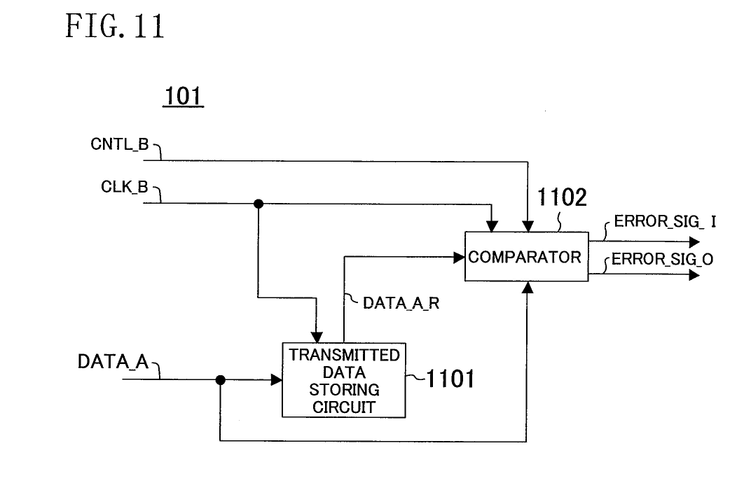

FIG. 11 shows an asynchronous anomaly detecting circuit 101 which determines whether the aforementioned relationship is satisfied. A receive clock CLK_B, a control signal CNTL_B, and transmitted data DATA_A correspond to Asyn_SIG_I1 of FIG. 1.

The asynchronous anomaly detecting circuit 101 of FIG. 11 includes a transmitted data storing circuit 1101 which stores transmitted data which was input one receive clock cycle before, and a comparator 1102 which receives the latest transmitted data DATA_A, transmitted data DATA_A_R held by the transmitted data storing circuit 1101, and the control signal CNTL_B, and compares the transmitted data DATA_A with the transmitted data DATA_A_R one receive clock cycle before, with the timing of a rising edge of the receive clock CLK_B.

After detection of the first destination clock edge since the control signal CNTL_B becomes valid, the comparator 1102 compares the transmitted data DATA_A_R held in the transmitted data storing circuit 1101 with the latest transmitted data DATA_A. If the two pieces of data match, the comparator 1102 also compares the transmitted data DATA_A R held in the transmitted data storing circuit 1101 with the latest transmitted data DATA_A at the next clock edge. In this case, at the same time it is determined whether the control signal CNTL_B remains valid. If the two pieces of data do not match or the control signal CNTL_B is invalid upon comparison, the comparator 1102 determines that an anomaly has occurred and outputs asynchronous anomaly information ERROR_SIG_I and ERROR_SIG_O containing the timing of the occurrence of the anomaly. Note that the comparator 1102 ends comparison when the control signal CNTL_B becomes invalid.

### Embodiment 4

In the asynchronous anomaly removing circuit 102 of Embodiment 1, a configuration is provided which removes an asynchronous anomaly by extending the length of a data signal.

As described in Embodiment 2, when transmitted data is not held for a sufficient time period, data may not be normally transferred. To prevent this, it is necessary to extend the length of transmitted data.

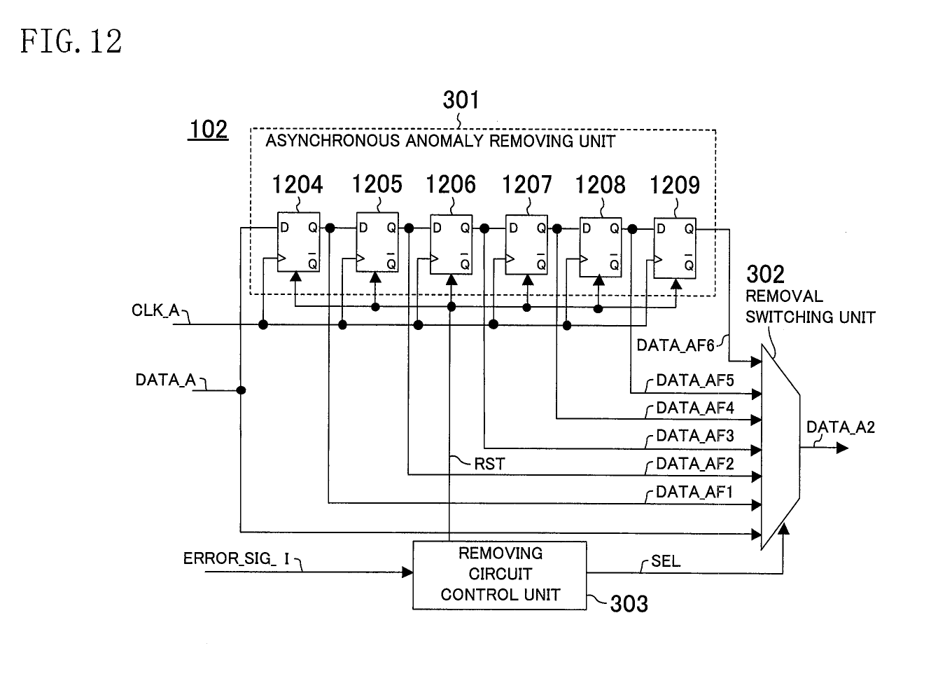

FIG. 12 shows an example asynchronous anomaly removing circuit 102 which extends the length of transmitted data using a data delay flip-flop. The asynchronous anomaly removing circuit 102 includes an asynchronous anomaly removing unit 301 including data delay flip-flops 1204 to 1209 linked in series, each delay flip-flop operating with a transmit clock CLK_A, a removing circuit control unit 303 which generates and outputs a data line switching control signal SEL for switching connection to an input data line DATA_A2 of a destination flip-flop from an output data line DATA_A of a source flip-flop to one of output data lines DATA_AF1 to DATA_AF6 of the data delay flip-flops when removing an asynchronous anomaly, and a removal switching unit 302 including a selector for receiving the output data line DATA_A of the source flip-flop and the output data lines DATA_AF1 to DATA_AF6 of the data delay flip-flops and selecting the input data line DATA_A2 of the destination flip-flop in accordance with the data line switching control signal SEL as a control signal.

In the asynchronous anomaly removing unit 301, each data delay flip-flop can delay data by one transmit clock cycle. When six data delay flip-flops are linked in series as shown in FIG. 12, data can be delayed by six transmit clock cycles. Although FIG. 12 shows an example in which the six data delay flip-flops 1204 to 1209 are linked, the number of linked flip-flops may be set, depending on how much the data length is to be extended. By using one of the output signals of the data delay flip-flops 1204 to 1209 as input data to the destination flip-flop, transmitted data can be extended. The removing circuit control unit 303 receives the asynchronous anomaly information ERROR_SIG_I output from the asynchronous anomaly detecting circuit 101, and based on this information, generates the data line switching control signal SEL for selecting the outputs of the data delay flip-flops 1204 to 1209. The removing circuit control unit 303 also receives the output data line DATA_A of the source flip-flop, and when determining based on DATA_A that the source flip-flop is in the idle state, supplies to the data delay flip-flops 1204 to 1209 a signal RST for resetting them. Note that the output data line DATA_A of the source flip-flop corresponds to Asyn_SIG_I2 of FIG. 1, and DATA_A2 corresponds to Asyn_SIG_O of FIG. 1.

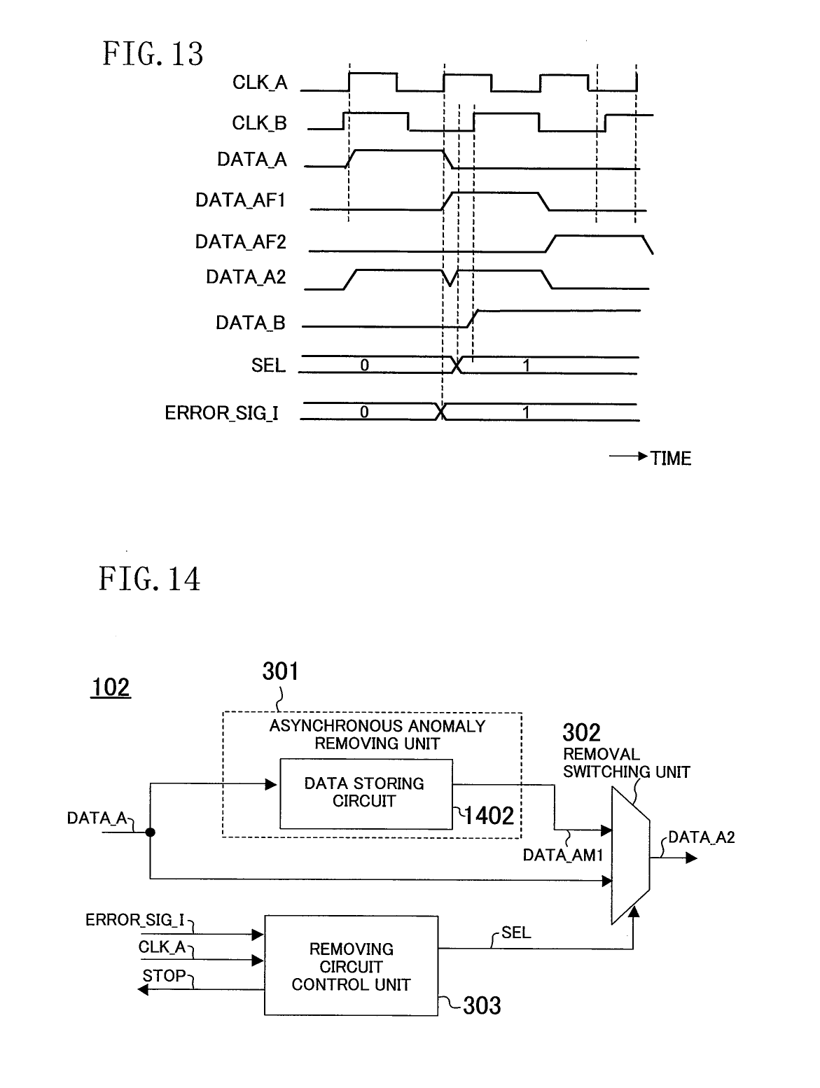

FIG. 13 shows a timing chart when an asynchronous anomaly is detected and therefore the asynchronous anomaly removing circuit 102 of FIG. 12 is enabled. As described in Embodiment 2, when data DATA_A to be transmitted changes before the next rising edge of the receive clock CLK_B, the data is not normally transferred to the data destination flip-flop. When detecting such a state, the asynchronous anomaly detecting circuit 101 outputs asynchronous anomaly information ERROR_SIG_I. This asynchronous anomaly information ERROR_SIG_I has a value of more than 0 and indicates an anomaly. The value indicates the number of extended cycles of transmitted data required so as to normally transfer data. When receiving ERROR_SIG_I, the removing circuit control unit 303 calculates the sum of a data length extended in the past and the number of extended cycles required, and outputs the sum value as the data line switching control signal SEL. In FIG. 13, the number of extended cycles required is 1, and the data length extended in the past is 0. In this case, the data line switching control signal SEL selects DATA_AF1. Therefore, as can be seen from DATA_A2, the output DATA_AF1 delayed by one cycle of the transmit clock CLK_A is input to the destination flip-flop, i.e., the data is extended by one cycle. Note that the asynchronous anomaly removing circuit 102 can be applied as a removing circuit which is combined with Embodiment 3 in addition to Embodiment 2.

### Embodiment 5

In the asynchronous anomaly removing circuit 102 of Embodiment 4 which removes an asynchronous anomaly by extending the length of a data signal, a configuration is provided which employs a single data storing circuit to extend the data signal length instead of the configuration in which a plurality of data delay flip-flops are linked in series. The configuration employing a single data storing circuit will be described.

FIG. 14 shows an example asynchronous anomaly removing circuit 102 which employs a single data storing circuit 1402 to extend the length of transmitted data. The asynchronous anomaly removing circuit 102 includes an asynchronous anomaly removing unit 301 including the data storing circuit 1402 for temporarily storing transmitted data DATA_A in synchronization with a transmit clock CLK_A so as to compensate for data in a destination when transmitted data is lost, a removing circuit control unit 303 which generates and outputs a control signal SEL for switching input data to a destination flip-flop to an output data line of the data storing circuit 1402 during removal, and instructs a source clock domain circuit to temporarily stop the next data transmission since an anomaly is being removed from transmitted data, and a removal switching unit 302 which switches paths so as to input data DATA_AM1 into the destination flip-flop when an anomaly is removed from transmitted data.

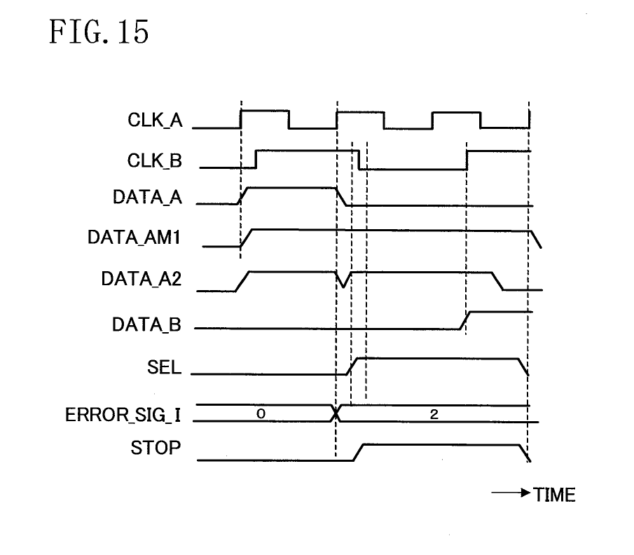

FIG. 15 shows a timing chart when an asynchronous anomaly is detected and the asynchronous anomaly removing circuit 102 of FIG. 14 is enabled. As described in Embodiment 4, when data DATA_A to be transmitted changes before the next rising edge of a receive clock CLK_B, data is not normally transferred to a data source flip-flop. When detecting this state, an asynchronous anomaly detecting circuit 101 outputs asynchronous anomaly information ERROR_SIG_I. This asynchronous anomaly information ERROR_SIG_I has a value of more than 0, indicating an anomaly. The value indicates the number of extended cycles of transmitted data required so as to normally transfer data. In the case of FIG. 15, transmitted data is 2 cycles short.

The removing circuit control unit 303, when receiving the asynchronous anomaly information ERROR_SIG_I, generates a control signal SEL for selecting transmitted data stored in the data storing circuit 1402 for two transmission cycles. The removing circuit control unit 303 also generates a control signal STOP for instructing a source clock domain circuit to temporarily stop transmitting the next data since an anomaly is being removed from transmitted data, for two transmission cycles. As a result, transmitted data is normally transferred to the destination flip-flop.

### Embodiment 6

In Embodiment 1, a configuration is provided which includes an asynchronous anomaly detecting circuit and an asynchronous anomaly removing circuit. The asynchronous anomaly detecting circuit detects a “metastable” asynchronous anomaly that when a data value changes upon clock transition of a destination flip-flop, the output of the destination flip-flop fluctuates for a finite time, and the value is indefinite for that time. This configuration will be described.

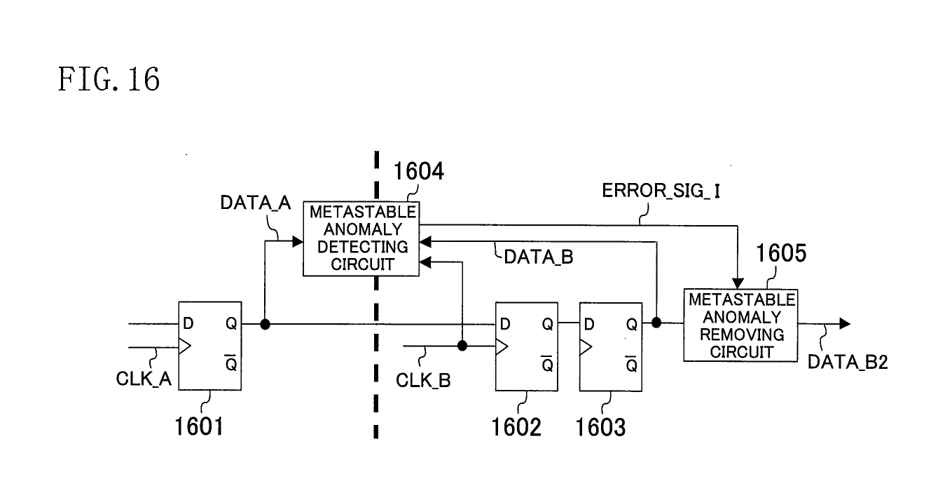

FIG. 16 shows a circuit configuration which detects and removes a metastable anomaly in an asynchronous data transfer circuit. The circuit configuration includes a source flip-flop 1601, a first destination flip-flop 1602, a second destination flip-flop 1603 connected for taking measures against metastability, a metastable anomaly detecting circuit 1604 which receives transmitted data DATA_A, a receive clock CLK_B, and an output DATA_B of the second destination flip-flop, and outputting metastable anomaly information ERROR_SIG_I, and a metastable anomaly removing circuit 1605 which receives the metastable anomaly information ERROR_SIG_I and removing a metastable anomaly. DATA_B2 indicates received data after the removal process.

The metastable anomaly detecting circuit 1604 monitors asynchronous data transfer to determine whether a data transfer anomaly has occurred due to metastability, and when a metastable anomaly has occurred, outputs metastable anomaly information ERROR_SIG_I and ERROR_SIG_O. The metastable anomaly removing circuit 1605 receives the metastable anomaly information ERROR_SIG_I, and when a metastable anomaly has occurred, removes the metastable anomaly.

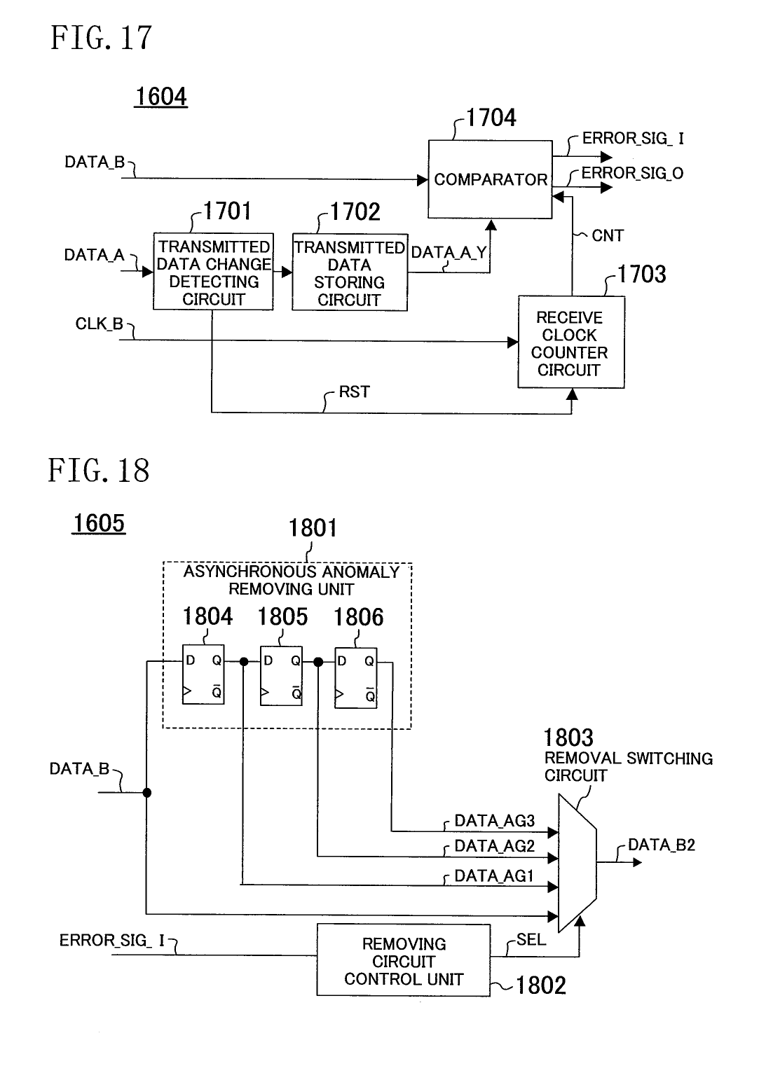

FIG. 17 is a diagram for describing an example configuration of the metastable anomaly detecting circuit 1604 in more detail. The metastable anomaly detecting circuit 1604 includes a transmitted data change detecting circuit 1701 which detects a change in transmitted data DATA_A, a transmitted data storing circuit 1702 which temporarily stores transmitted data DATA_A as it is upon the data change, a receive clock counter circuit 1703 which starts counting a receive clock CLK_B since transmitted data changes, and a comparator 1704 which compares a value of output DATA_B of the second destination flip-flop with a value of transmitted data DATA_A_Y as it is upon the data change, which is stored in the transmitted data storing circuit 1702.

The transmitted data change detecting circuit 1701, when detecting a change in transmitted data DATA_A, stores the transmitted data DATA_A into the transmitted data storing circuit 1702. At the same time, the transmitted data change detecting circuit 1701 resets the receive clock counter circuit 1703 using a reset signal RST. As a result, at the same time the receive clock counter circuit 1703 starts counting the receive clock CLK_B. The comparator 1704 receives the latest received data DATA_B, the transmitted data DATA_A Y output from the transmitted data storing circuit 1702, and a count value CNT output from the receive clock counter circuit 1703. The comparator 1704 holds a value indicating the number of flip-flops previously inserted and connected therein so as to take measures against metastability. When the number of cycles that is the number of inserted flip-flops plus 1 matches the count value CNT, the comparator 1704 compares the latest received data DATA_B with the transmitted data DATA_A_Y output from the transmitted data storing circuit 1702 to confirm that they match. If the two pieces of data do not match, the comparator 1704 determines that a metastable anomaly has occurred, and outputs asynchronous anomaly information ERROR_SIG_I and ERROR_SIG_O.

FIG. 18 shows an example configuration of the metastable anomaly removing circuit 1605 which removes a metastable anomaly. The metastable anomaly removing circuit 1605 includes an asynchronous anomaly removing unit 1801 in which a plurality of anti-metastable flip-flops 1804 to 1806 are connected in series, a removing circuit control unit 1802 which outputs a control signal SEL for switching a signal to be output to the received data DATA_B2 after the removal process of FIG. 16 from the output data DATA_B of the destination flip-flop to data lines DATA_AG1 to DATA_AG3 output via the anti-metastable flip-flops 1804 to 1806, and a removal switching unit 1803 which includes a selector for selecting data to be output to the received data line DATA_B2 in accordance with the control signal SEL. The removing circuit control unit 1802, when receiving the asynchronous anomaly information ERROR_SIG_I, generates the control signal SEL, and switches an output path from DATA_B to DATA_B2 to a path from DATA_B via one of DATA_AG1 to DATA_AG3.

### Embodiment 7

An example of the output unit 202 of Embodiment 1 (FIG. 2) which outputs asynchronous anomaly information to the outside will be described.

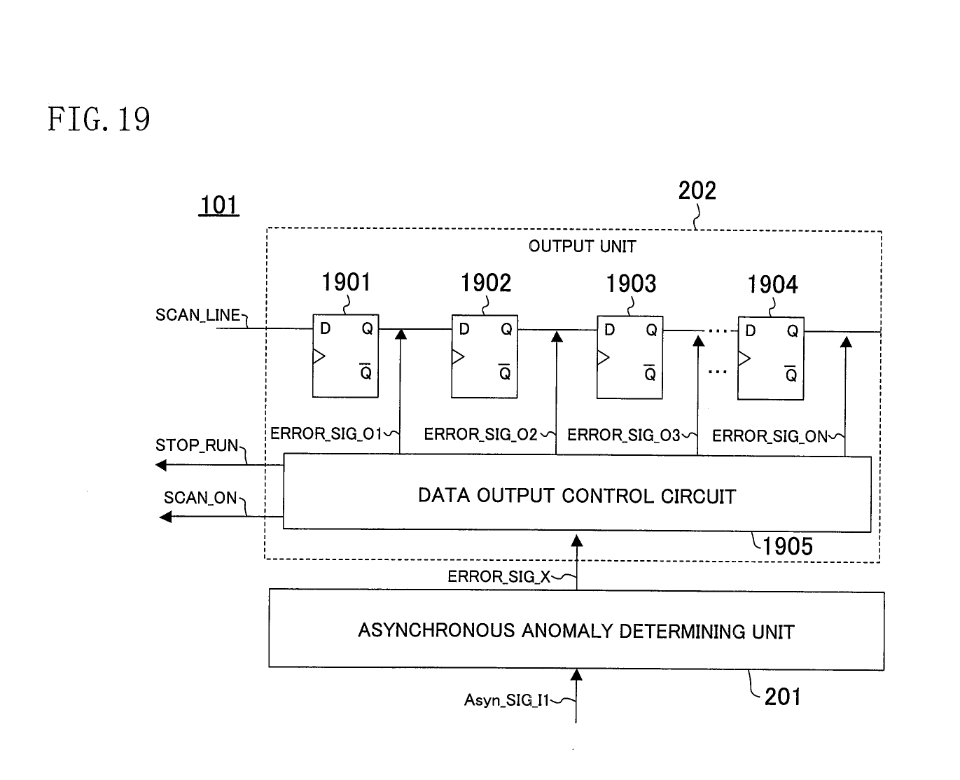

FIG. 19 is a diagram showing a configuration in which the output unit 202 which outputs asynchronous anomaly information to the outside is configured in a scan chain. An asynchronous anomaly detecting circuit 101 of FIG. 19 includes an asynchronous anomaly determining unit 201 which determines whether an input signal satisfies desired signal conditions with respect to predetermined signal conditions which should be satisfied so as to normally pass data, and an output unit 202 which outputs asynchronous anomaly information to the outside. The output unit 202 includes scan flip-flops 1901 to 1904 connected to a scan line SCAN_LINE, and a data output control circuit 1905 which controls a data output.

When the asynchronous anomaly determining unit 201 detects an asynchronous anomaly, the data output control circuit 1905 generates a control signal STOP RUN which stops and switches an operation of a semiconductor integrated circuit to a test mode. When the semiconductor integrated circuit is switched to the test mode, the data output control circuit 1905 divides asynchronous anomaly information ERROR_SIG_X input from the asynchronous anomaly determining unit 201 to N bits, i.e., ERROR_SIG_O1 to ERROR_SIG_ON, which are set into the scan flip-flops 1901 to 1904. Next, the data output control circuit 1905 generates a control signal SCAN_ON for setting a scan mode so as to output the asynchronous anomaly information ERROR_SIG_O1 to ERROR_SIG_ON set in the scan flip-flops 1901 to 1904 to the outside. As a result, the scan chain operates, and asynchronous anomaly information is output via the scan chain to the outside.

### Embodiment 8

In the asynchronous anomaly detecting circuit 101 of Embodiment 1, a configuration is provided which further includes storage means for storing a history of signal states of asynchronous passing related signals Asyn_SIG_I1 and Asyn_SIG_I2 for a predetermined time, for the purpose of debugging. This configuration will be described.

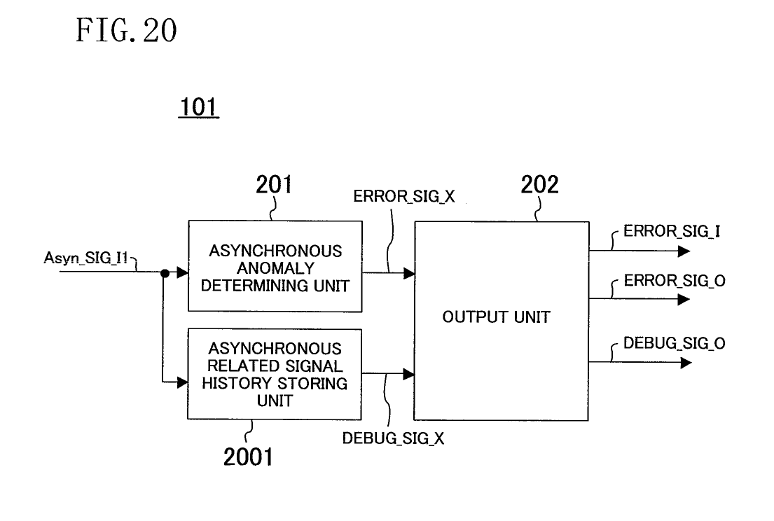

FIG. 20 is a diagram showing an example configuration of the asynchronous anomaly detecting circuit 101 further including a memory device. This configuration is obtained by adding an asynchronous related signal history storing unit 2001 to the configuration of the asynchronous anomaly detecting circuit 101 of FIG. 2. The asynchronous related signal history storing unit 2001 includes a memory device, and stores the signal history of the asynchronous passing related signals Asyn_SIG_I1 for a predetermined time since an asynchronous anomaly is detected. If the capacity of the memory is full, the signal history is updated by overwriting an old history. Asynchronous related signal history information DEBUG_SIG_X output from the asynchronous related signal history storing unit 2001 is input to the output unit 202, and can be output as debug information DEBUG_SIG_O to the outside via the output unit 202.

### Embodiment 9

A method for controlling a semiconductor integrated circuit including the asynchronous anomaly detecting circuit 101 and the asynchronous anomaly removing circuit 102 which have been described in Embodiment 1, will be described.

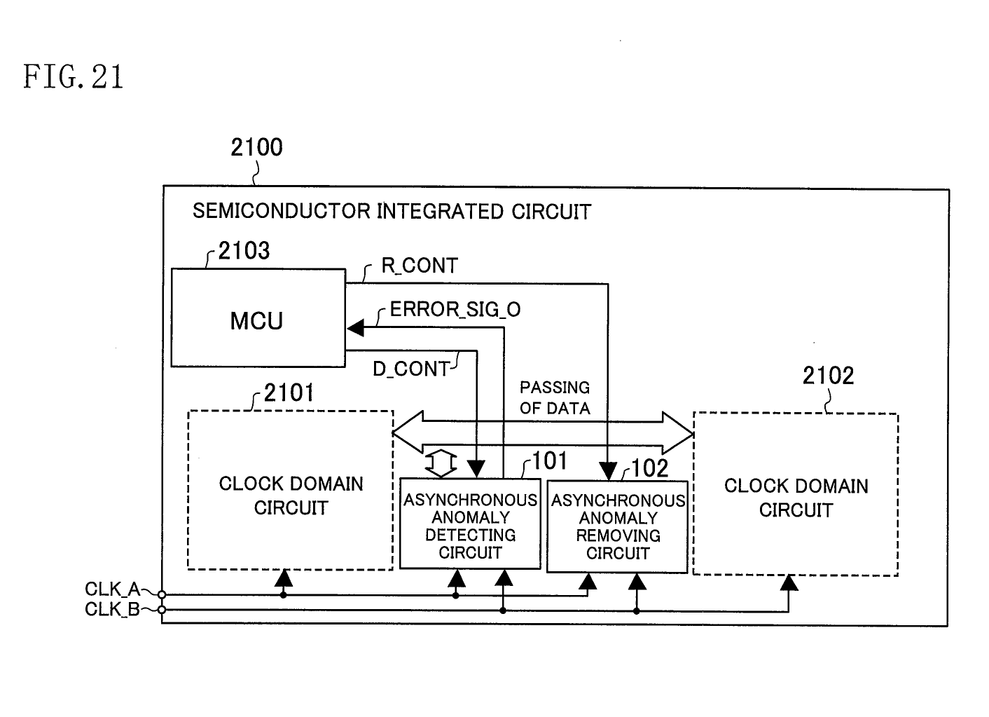

FIG. 21 is a diagram showing an example configuration of a system which controls the asynchronous anomaly detecting circuit 101 and the asynchronous anomaly removing circuit 102 in a semiconductor integrated circuit 2100 which includes the asynchronous anomaly detecting circuit 101 and the asynchronous anomaly removing circuit 102. The system includes the asynchronous anomaly detecting circuit 101, the asynchronous anomaly removing circuit 102, a first clock domain circuit 2101, a second clock domain circuit 2102, and a microcontroller unit (MCU) 2103 which controls an entire system. The MCU 2103 controls the asynchronous anomaly detecting circuit 101 via a control line D_CONT and the asynchronous anomaly removing circuit 102 via another control line R_CONT in any manner using respective pieces of software.

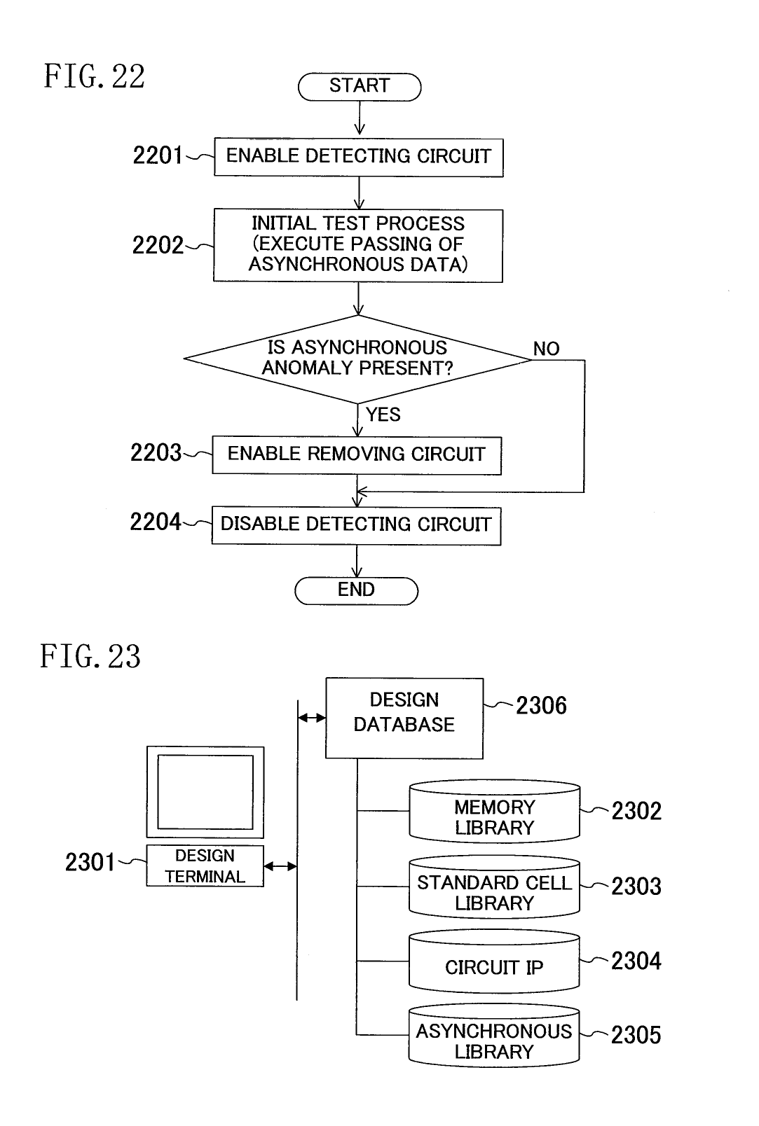

FIG. 22 shows an example initial startup routine of the semiconductor integrated circuit 2100 including the asynchronous anomaly detecting circuit 101 and the asynchronous anomaly removing circuit 102, which is executed using the MCU 2103. The initial startup routine includes a detecting circuit enabling step 2201 which enables the asynchronous anomaly detecting circuit 101, an initial test processing step 2202 which performs an initial test, a removing circuit enabling step 2203 which enables the asynchronous anomaly removing circuit 102 when an asynchronous anomaly has occurred, and a detecting circuit disabling step 2204 which disables the asynchronous anomaly detecting circuit 101 after the end of the initial test process.

### Embodiment 10

An example design flow for incorporating into a semiconductor integrated circuit the asynchronous anomaly detecting circuit 101 and the asynchronous anomaly removing circuit 102 which have been described in Embodiment 1, will be described.

FIG. 23 is a diagram showing an example design environment for designing the semiconductor integrated circuit. The design environment includes a design terminal 2301, a memory library 2302, a standard cell library 2303, a circuit IP 2304, an asynchronous library 2305, and a design database 2306. Although the asynchronous library 2305 is not typically included, the asynchronous library 2305 is here newly added so as to incorporate the asynchronous anomaly detecting circuit 101 and the asynchronous anomaly removing circuit 102 of the present invention.

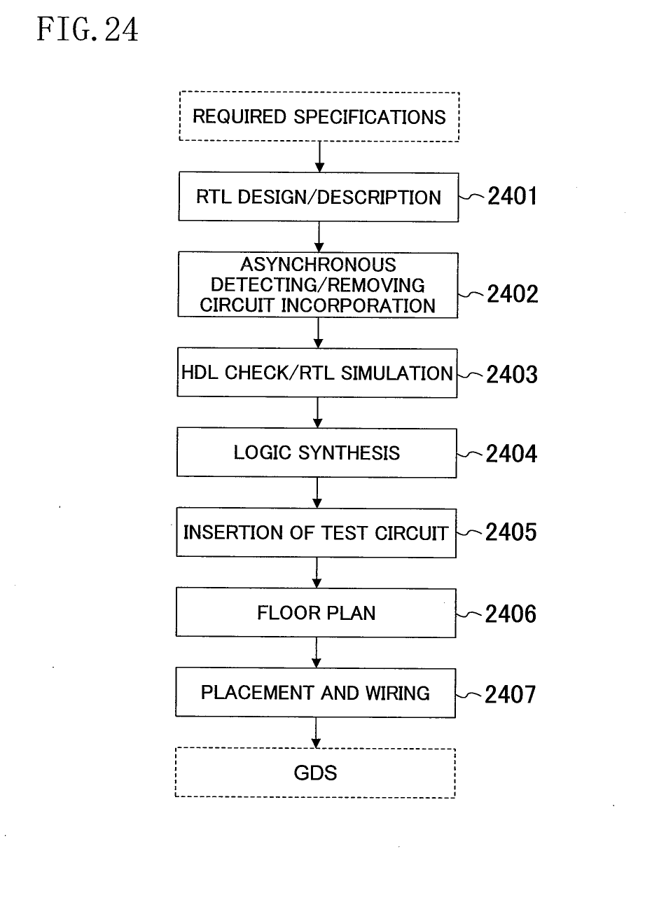

FIG. 24 is a diagram showing an example design flow for incorporating the asynchronous anomaly detecting circuit 101 and the asynchronous anomaly removing circuit 102 into a semiconductor integrated circuit. The design flow includes an RTL design/description step 2401 which describes required functional specifications in a hardware description language, an asynchronous detecting/removing circuit incorporating step 2402, an HDL check RTL simulation step 2403 which verifies an RTL description, a logic synthesis step 2404 which performs logic synthesis of an RTL description, a test circuit inserting step 2405 which inserts a test circuit, a floor plan step 2406 which produces a floor plan for a chip layout, an a placement and wiring step 2407 which places gates and memories of a netlist and provides wiring connecting them on a floor plan. The asynchronous detecting/removing circuit incorporating step 2402 is newly added so as to incorporate the asynchronous anomaly detecting circuit 101 and the asynchronous anomaly removing circuit 102 of the present invention.

In the asynchronous detecting/removing circuit incorporating step 2402, an asynchronous library 2305 including the asynchronous anomaly detecting circuit 101 and the asynchronous anomaly removing circuit 102 is used to incorporate these circuits into RTL data. The asynchronous anomaly detecting circuit 101 and the asynchronous anomaly removing circuit 102 incorporated in RTL data are automatically converted into a cell library by the logic synthesis step 2404 and the placement and wiring step 2407 before being arranged on an actual chip.

### INDUSTRIAL APPLICABILITY

As described above, the semiconductor integrated circuit of the present invention and its design method allow easy detection of an asynchronous anomaly using an asynchronous anomaly detecting circuit during evaluation of a chip or a product incorporating the chip even when an asynchronous passing point is not well verified during a design stage in an asynchronous passing portion which is difficult to perfectly verify, and an asynchronous anomaly is left in a developed chip, and have an effect of correcting circuit data, or repairing an anomaly point without remodeling a mask, by enabling the asynchronous anomaly removing circuit even when a circuit anomaly is detected during evaluation of a chip or a product incorporating the chip. As a result, the semiconductor integrated circuit of the present invention and its design method are useful for passing of data between asynchronous clock domains, and the like.

1. A semiconductor integrated circuit for passing data between asynchronous clock domains operating with different clocks, comprising:
an asynchronous anomaly detecting circuit having an asynchronous anomaly determining unit for receiving clock signals asynchronous with each other and a signal related to passing of data as input signals, and determining whether the input signals satisfy desired signal conditions.

2. The semiconductor integrated circuit of claim 1, wherein
the asynchronous anomaly detecting circuit further include an output unit for outputting circuit anomaly information to the outside when the desired signal conditions are not satisfied.

3. The semiconductor integrated circuit of claim 1, further comprising:
an asynchronous anomaly removing circuit having an asynchronous anomaly removing unit for modifying a signal state at an asynchronous passing point so as to satisfy the desired conditions when conditions under which data transfer is normally performed are not satisfied.

4. The semiconductor integrated circuit of claim 3, wherein
the asynchronous anomaly removing circuit further includes:
a removal switching unit for enabling or disabling the asynchronous anomaly removing unit with respect to a circuit anomaly point; and
a removing circuit control unit for managing and recognizing a removal state and generating and outputting a control signal for controlling the removing circuit.

5. The semiconductor integrated circuit of claim 1,
the asynchronous anomaly detecting circuit receives a destination clock, a source clock and transmitted data, and when the destination clock has a frequency lower than that of the source clock, detects a data change in the transmitted data, and from that time, monitors the transmitted data to determine whether the transmitted data has changed during a predetermined clock cycle of the destination clock, and when the transmitted data has changed during the predetermined clock cycle of the destination clock, outputs circuit anomaly information.

6. The semiconductor integrated circuit of claim 1, wherein
the asynchronous anomaly detecting circuit receives a receive clock, transmitted data, and a control signal indicating that the transmitted data is valid, and monitors the transmitted data to determine whether the transmitted data has changed during a predetermined time before and after a change in the control signal, and when the transmitted data has changed during the predetermined time before and after the change in the control signal, outputs circuit anomaly information.

7. The semiconductor integrated circuit of claim 3, wherein
the asynchronous anomaly removing circuit, when transmitted data has a too short length to be normally transferred to a destination, compensates for transmitted data lost before being transferred to the destination.

8. The semiconductor integrated circuit of claim 7, wherein
the asynchronous anomaly removing circuit includes:
an asynchronous anomaly removing unit for extending a length of transmitted data, the asynchronous anomaly removing unit including a plurality of data delay flip-flops operating with a source clock;
a removing circuit control unit for generating and outputting a control signal for switching input data to a destination flip-flop to an output data line of the data delay flip-flop during removal; and
a removal switching unit including a selector for receiving an output data line of a source flip-flop and the output data line of the data delay flip-flop, and selecting a data line to be input to the destination flip-flop in accordance with the data line switching control signal as a control signal.

9. The semiconductor integrated circuit of claim 7, wherein
the asynchronous anomaly removing circuit includes:
an asynchronous anomaly removing unit including a data storing circuit for temporarily storing transmitted data in synchronization with a transmit clock so as to compensate for the transmitted data at a destination when the transmitted data is lost;
a removing circuit control unit for generating and outputting a control signal for switching input data to a destination flip-flop to an output data line of the data storing circuit during removal, and instructs a source clock domain circuit to temporarily stop the next data transmission since an anomaly is being removed from transmitted data; and
a removal switching unit for switching paths so as to input data stored in the data storing circuit to a destination flip-flop when an anomaly is removed from transmitted data.

10. The semiconductor integrated circuit of claim 1, wherein
the asynchronous anomaly detecting circuit includes a metastable anomaly detecting circuit for monitoring transmitted data output by a source flip-flop and received data output by one or more anti-metastable flip-flops connected in series to a destination flip-flop to determine whether the transmitted data and the received data match during a cycle following a time when a change occurs in the transmitted data of the source flip-flop, where a receive clock cycle is a unit time and the number of the one or more anti-metastable flip-flops is the number of cycles, and when the transmitted data and the received data do not match, outputting circuit anomaly information.

11. The semiconductor integrated circuit of claim 10, wherein
the metastable anomaly detecting circuit includes:
a transmitted data change detecting circuit for receiving transmitted data of a source flip-flop, and when detecting a change in the transmitted data, outputting transmitted data change information;
a transmitted data storing circuit for temporarily storing transmitted data of the source flip-flop when the transmitted data changes;
a receive clock counter circuit for receiving a receive clock and the transmitted data change information, and when a data change is detected, being reset; and
a comparator for receiving the transmitted data stored in the transmitted data storing circuit, received data of the anti-metastable flip-flop, and a count value of the receive clock counter circuit, and when the count value indicates a desired count value, determining whether the transmitted data stored in the transmitted data storing circuit matches the received data of the anti-metastable flip-flop.

12. The semiconductor integrated circuit of claim 2, wherein the output unit includes:
encoding means for converting signal state information into simple codes;
means for stopping an entire system, and storing bit information encoded by the encoding means into a flip-flop on a scan chain provided in a vicinity of an asynchronous point;
means for switching the system to a test mode; and
means for transferring signal information on a scan path to the outside.

13. The semiconductor integrated circuit of claim 1, wherein
the asynchronous anomaly detecting circuit further includes:
an asynchronous related signal history storing unit including a storage device for storing a history of an asynchronous related signal for a predetermined time.

14. The semiconductor integrated circuit of claim 3, further comprising:
a control device for controlling an entire system of the semiconductor integrated circuit,
wherein the control device includes:
detecting circuit enabling means for enabling the asynchronous anomaly detecting circuit during a self initialization test when the system is started up;
removing circuit enabling means for enabling the asynchronous anomaly removing circuit with respect to an anomaly point when the asynchronous anomaly detecting circuit detects an asynchronous anomaly; and
detecting circuit disabling means for stopping an operation of the asynchronous anomaly detecting circuit during an ordinary operation mode.

15. A method for designing a semiconductor integrated circuit, comprising:
creating and reusing a library of the asynchronous anomaly detecting circuit and the asynchronous anomaly removing circuit of the semiconductor integrated circuit of claim 3, and reusing the asynchronous anomaly detecting circuit and the asynchronous anomaly removing circuit.
